(19) United States
(12) Patent Application Publication
(10) Pub. No.: US 2024/0403461 A1
(43) Pub. Date: Dec. 5, 2024

(54) PREVENTION OF DATA LEAKAGE

(71) Applicant: INTERNATIONAL BUSINESS MACHINES CORPORATION, Armonk, NY (US)

(72) Inventors: Chengxuan XING, Winchester (GB); Benjamin Graham THOMPSON, HURSLEY (GB); John Anthony REEVE, HURSLEY (GB); John HOSIE, Eastleigh (GB)

(21) Appl. No.: 18/203,986

(22) Filed: May 31, 2023

(51) Int. Cl. G06F 21/62; G06F 21/60

(52) U.S. Cl. CPC G06F 21/6218; G06F 21/604

(57) ABSTRACT

A method, system, and computer program product that is configured to: receive inbound data; tag a plurality of data fields of the inbound data; execute at least one integration flow which transforms the inbound data with tagged data fields to transformed data with the tagged data fields; obscure values of the data fields in the transformed data based on the tagged data fields; and send outbound data which includes the transformed data with the obscured values of the data fields.

### BACKGROUND

Aspects of the present invention relate generally to prevention of data leakage and, more particularly, to prevention of data leakage between systems during a runtime integration.

Enterprise integrations are widely adopted in a modern business climate. Further, enterprise integrations usually involve data transportation from one system to another. Also, in most business organizations, security rules are tightly controlled by a separate security team that is different from a team overseeing an enterprise integration.

### SUMMARY

In a first aspect of the invention, there is a computer-implemented method including: receiving, by a processor set, inbound data; tagging, by the processor set, a plurality of data fields of the inbound data; executing, by the processor set, at least one integration flow which transforms the inbound data with tagged data fields to transformed data with the tagged data fields; obscuring, by the processor set, values of the data fields in the transformed data based on the tagged data fields; and sending, by the processor set, outbound data which includes the transformed data with the obscured values of the data fields.

In another aspect of the invention, there is a computer program product including one or more computer readable storage media having program instructions collectively stored on the one or more computer readable storage media. The program instructions are executable to: receive inbound data from a source system; tag a plurality of data fields of the inbound data; execute at least one integration flow utilizing hashing functions which transforms the inbound data with tagged data fields to transformed data with the tagged data fields; obscure values of the data fields in the transformed data based on the tagged data fields; and send outbound data which includes the transformed data with the obscured values of the data fields to a target system.

In another aspect of the invention, there is a system including a processor set, one or more computer readable storage media, and program instructions collectively stored on the one or more computer readable storage media. The program instructions are executable to: receive inbound data from a source system; tag a plurality of data fields of the inbound data; execute at least one integration flow comprising copying entries of an incoming message tree to another message tree which transforms the inbound data with tagged data fields to transformed data with the tagged data fields; obscure values of the data fields in the transformed data based on the tagged data fields; and send outbound data which includes the transformed data with the obscured values of the data fields to a target system.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment of an integration runtime server in accordance with aspects of the present invention.

FIG. 3 shows a flowchart of an exemplary method of the integration runtime server in accordance with aspects of the present invention.

FIG. 4 shows a block diagram of a value obscuring module in accordance with aspects of the present invention.

FIG. 5 shows a flowchart of an exemplary method of the value obscuring module in accordance with aspects of the present invention.

FIG. 6 shows a block diagram of an exemplary environment of a security rules management module in accordance with aspects of the present invention.

FIG. 7 shows a flowchart of an exemplary method of the security rules management module in accordance with aspects of the present invention.

FIG. 8 shows an example of customer information in an internal database in accordance with aspects of the present invention.

### DETAILED DESCRIPTION

Aspects of the present invention relate generally to prevention of data leakage and, more particularly, to prevention of data leakage between systems during a runtime integration. Embodiments of the present invention enable checking of in-memory hierarchical data structures and associated taints at various points in an integration flow and prior to serializing and sending the data over a network to another system. In aspects of the present invention, a taint associated with an in-memory hierarchical data structure protects a program from an illegal memory access. In embodiments, a taint represents a marking of sensitive or secret data. Embodiments of the present invention enable taints of the in-memory hierarchical data structures to be altered at various transformation steps to allow for tracking of data changes and inheritance rules associated with data. In aspects of the present invention, inheritance rules may be a function of a source, a destination, a path of a data field within a hierarchical structure (e.g., a different taint may be applied to different structures, such as customer address of an order versus billing credit card information of the order), an application of a transformation (e.g., upperstring function does not change taints, but checksum function does change taints), and/or an application of enrichment and/or aggregations (e.g., sending post code, a phone number, or a surname are not sensitive by themselves, but a combination of the post code, the phone number, and the surname causes the combination to be sensitive personally identifiable information (PII) data). Embodiments of the present invention enable variable timing of the taints (e.g., taints may have expiry times which allow a field to be stored in a state for an integration engine and then forwarded to a destination at a future point in time). Embodiments of the present invention enable improved performance of an inbound and outbound system during an integration step execution (e.g., rules that are applied for a specific integration step may be filtered out, which reduces a number of rules to process and improves performance) in comparison to conventional enterprise integration.

Embodiments of the present invention enable programmable access control of data flow in an integration system by utilizing tagging and value obscuring as part of an integration step execution. Embodiments of the present invention enable programmable access control of data flow in an integration system by utilizing a security rules management module which generates a dynamic list of fields to be tagged for a specific integration step and a list of rules for an outbound integration step to check and obscure data when applicable. Conventional systems are not able to perform taint tracking for integration cases in which a list of sensitive fields are dynamically decided based on business need and scope. Further, conventional systems are not able to permit exposure of sensitive fields based on a targeting system of an outbound integration step.

Embodiments of the present invention utilize message trees to store data control tags to enable taint tracking in an integration running module. Embodiments of the present invention utilize a separated security rules management module which decouples security settings of an entire integration system from core business integration logic assets, enables a specification of a scope of a security rule for an integration system, and calculates scope-specific security rules, which reduces a number of rules to be executed and improves a performance of a security enforcement module. Conventional systems may accidentally leak confidential data due to integration developers not being aware that data retrieved from a system has confidential fields and then sending those confidential fields to another system. Further, conventional systems may accidentally leak confidential data due to confidential fields being added to objects used in a system, and the integration developer using these objects with confidential files as black boxes without knowing that these objects contain confidential files. Conventional systems also may utilize data from a third party system (e.g., a business partner) for a specific computing task, even though the data should not be viewed and/or copied (e.g., a retail company wants to feed customer search history into a customized artificial intelligence (AI) model to tailor a customer experience).

Embodiments of the present invention provide for receiving input data from multiple source applications, sending output data to multiple destination applications, and pulling data from multiple other network nodes in the middle of processing. Embodiments of the present invention provide for executing an orchestrated set of steps in a defined order and providing natural exit points in a process where enforcement rules are applied. Embodiments of the present invention provide for transformation of data before the data being passed to outbound applications. Embodiments of the present invention provide for code which is executed by an integration module as part of the transformation of the data. Embodiments of the present invention provide for access to confidential data sources and additional protection mechanisms for the confidential data sources. Embodiments of the present invention provide for protection mechanisms for a single feed of non-confidential data being used with other feeds of confidential data. Embodiments of the present invention provide for storing input data for a period of time before forwarding the data to a collection module, aggregation module, etc. Embodiments of the present invention provide for an in-memory hierarchical data structure which represents the data as it is being processed and flowing through an integration module.

Embodiments of the present invention provide for prevention of data leakage between systems during a runtime integration. Accordingly, implementations of aspects of the present invention provide an improvement (i.e., technical solution) to a problem arising in the technical field of data leakage between systems during enterprise integration. In particular, embodiments of the present invention include applying tags to individual fields in a data structure in response to the data structure being read from an external system, preserving the tags in response to the data structure being transformed into a different data structure within an integration flow, removing tags in response to a predetermined operation being performed, and checking tagged fields of a final data structure using a security rules management model before sending the final data structure to another external system. Also, embodiments of the present invention may not be performed mentally or may not be performed in a human mind because aspects of the present invention comprise enabling taint tracking by storing data control tags in an integration running module, decoupling security settings of an integration system from core business integration logic assets, enabling a scope of a security rule for the integration system, and reducing a number of security rules to be executed in the integration system to improve a performance of a security enforcement module. Further, these implementations of the present invention are necessarily rooted in computer technology because they improve the functioning of the computer.

Aspects of the present invention include a method, system, and computer program product for preventing data leakage between systems during the runtime integration. For example, a computer-implemented method includes: applying tags to individual fields in a data structure when read from an external system; and preserving the tags when the data structure is transformed into a different data structure within an integration flow. The integration flow of the computer-implemented method further includes removing tags when certain operations are performed and checking a final data structure tagged fields using a security rules management console before sending the final data structure to another external system.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as data leakage prevention code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

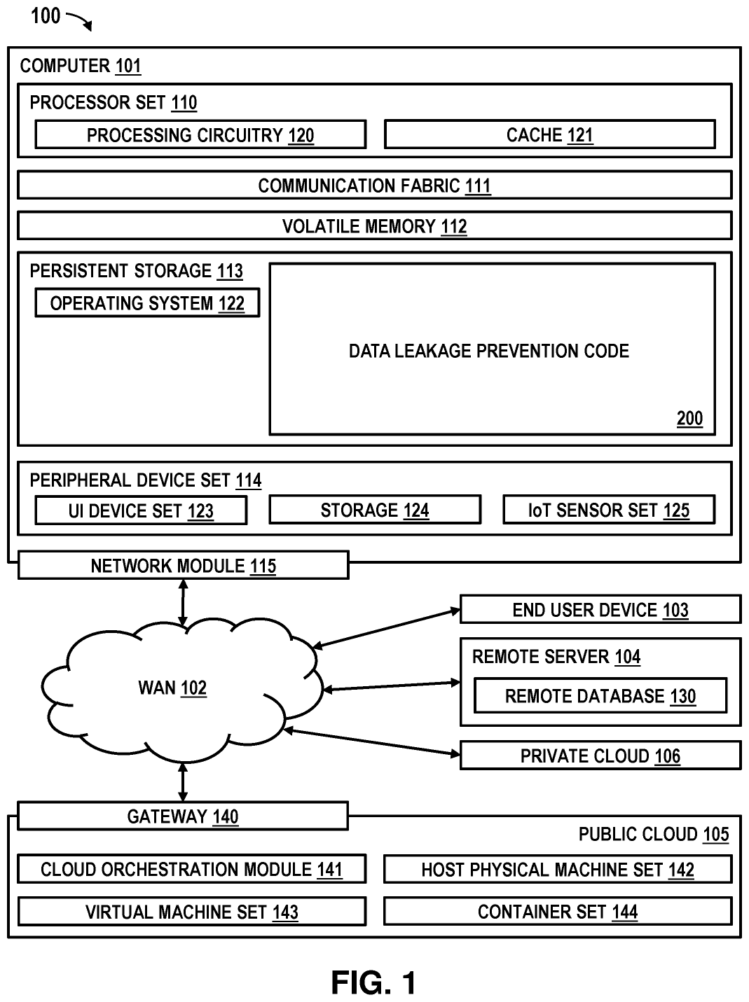

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

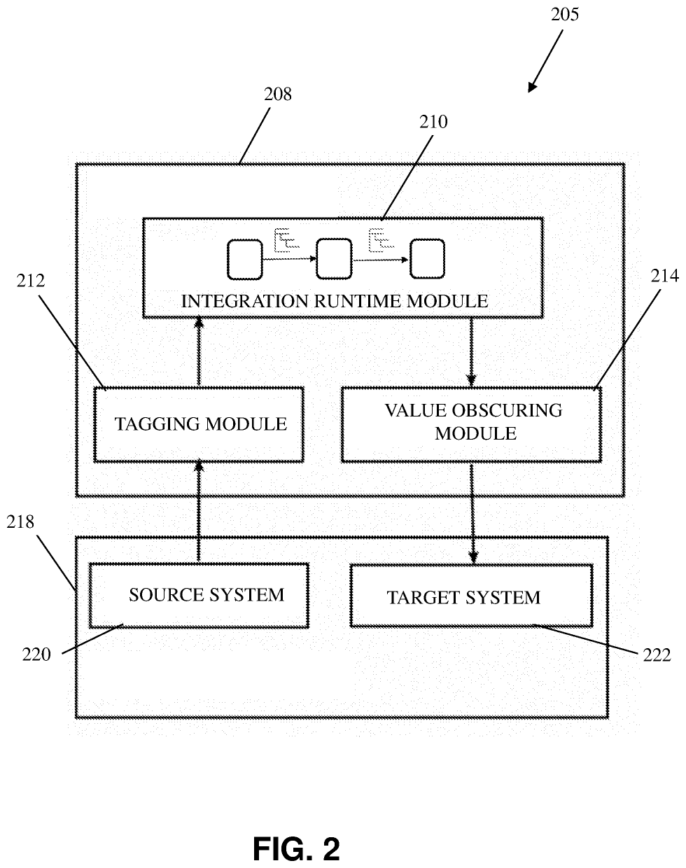

FIG. 2 shows a block diagram of an exemplary environment 205 in accordance with aspects of the invention. In embodiments, the environment 205 includes an integration runtime server 208, which may comprise one or more instances of the computer 101 of FIG. 1. In other examples, the integration runtime server 208 comprises one or more virtual machines or one or more containers running on one or more instances of the computer 101 of FIG. 1. In further embodiments, the environment 205 also includes an external system 218, which may comprise one or more instances of the remote server 104 of FIG. 1. In other examples, the external system 218 comprises one or more virtual machines or one or more containers running one or more instances of the computer 101 of FIG. 1. However, embodiments are not limited, and the environment 205 may only include the integration runtime server 208 and not include the external system 218. In an example, the external system 218 may be any system that is external to an integration flow.

In embodiments, the integration runtime server 208 of FIG. 2 comprises an integration runtime module 210, a tagging module 212, and a value obscuring module 214, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The integration runtime server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In FIG. 2, and in accordance with aspects of the invention, the integration runtime module 210 processes the integration flow. In embodiments, the integration flow is a flow within the integration runtime module 210 that occurs between receiving the inbound data with tagged data fields and outputting transformed data with the tagged data fields. In particular, the integration runtime module 210 includes an integration logic between multiple systems which are captured in the integration flow. Further, the integration runtime module 210 executes the integration flow during an integration runtime. In embodiments, the integration runtime module 210 stores data that is retrieved from multiple systems in a data storage device. In embodiments, the data storage device is created for running each integration flow. The integration runtime module 210 also constructs a message tree which comprises payload data that is sent to multiple systems. In embodiments, the integration runtime module 210 also stores the payload data that is sent to multiple systems in the message tree. In further embodiments, the integration runtime module 210 includes logic to process the retrieved payload data before the payload data gets stored in the message tree. The integration runtime module 210 also includes logic to process the payload data stored in the message tree before the payload data is sent to external systems (e.g., an external system 218). In embodiments, the integration flow may be a software as a service (SaaS) application.

In embodiments, the tagging module 212 utilizes security rules to add tags to data fields for inbound data that is stored in the message tree. In embodiments, tagging module 212 adds the tags to indicate a scope that will trigger a requirement for security rules. As an example, the tagging module 212 adds tags that are triggered when there is any data transportation within an integration flow. In another example, the tagging module 212 adds tags that are triggered when there is any data transportation between multiple integration flows.

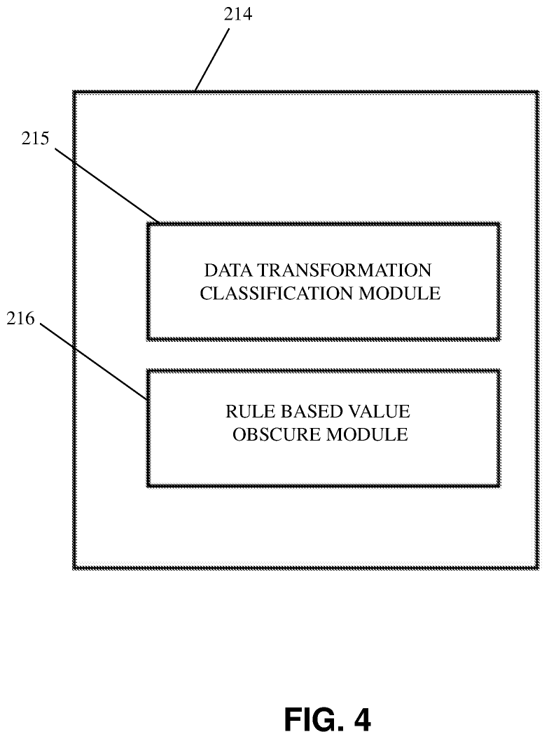

In embodiments, the value obscuring module 214 uses the security rules to obscure a value of data fields that should not be leaked according to the tagged data fields to an external system (e.g., an external system 218). The value obscuring module 214 comprises a data transformation classification module 215 and a rule based value obscure module 216. The transformation classification module 215 and the rule based value obscure module 216 are described herein with respect to FIG. 4. The data transformation classification module 215 identifies data fields that contain values that are calculated using data with tags. The data transformation classification module 215 classifies data transformation functions that are used to populate a value of each data field and assigns classification tags (e.g., reversible, irreversible). The rule based value obscure module 216 reads the scoped security rules for a current data transportation and obscures values in the data fields using the tags and the scoped security rules. Further details of the value obscuring module 214 are described herein with respect to FIG. 4.

In embodiments, the external system 218 comprises a source system 220 and a target system 222. In embodiments, the source system 220 includes source data for the integration runtime server 208. In particular, the source system 220 sends the source data to the tagging module 212. Accordingly, the tagging module 212 receives the inbound data (i.e., the source data) from the source system 220. Also, the target system 222 includes target data from the integration runtime server 208. In particular, the target system 222 receives the target data from the value obscuring module 214. Accordingly, the target system 222 receives the outbound data (i.e., the target data) from the value obscuring module 214. In other embodiments, the source system 210 and the target system 222 may be a same system for sending inbound data and receiving outbound data.

In FIG. 2, and in accordance with aspects of the invention, the source system 220 sends the source data to the tagging module 212. In embodiments, the tagging module 212 receives the inbound data (i.e., the source data) from the source system 220 and adds tags to data fields of the inbound data. The tagging module 212 then sends the inbound data with tagged data fields to the integration runtime module 210. The integration runtime module 210 executes at least one integration flow during an integration runtime. In an embodiment, the integration runtime module 210 executes at least one integration flow which transforms the inbound data with tagged data fields to transformed data with the tagged data fields. In an example, the transformation of data may include copying entries of an incoming message tree to another message tree and utilizing hashing functions, java code functions, etc. Accordingly, in embodiments, the integration runtime module 210 carries forward the tagged data fields even when the inbound data is transformed to transformed data (i.e., the transformed data is different data from the inbound data). The integration runtime module 210 sends the transformed data with the tagged data fields to the value obscuring module 214. In embodiments, the value obscuring module 214 receives the transformed data with the tagged data fields and uses the security rules corresponding to the tagged data fields to obscure values of the data fields that should not be leaked to the external system (e.g., the external system 218). After the value obscuring module 214 obscures any values of the data fields that should not be leaked to the external system 218, the value obscuring module 214 sends the transformed data with the tagged data fields and obscured data fields to the target system 222.

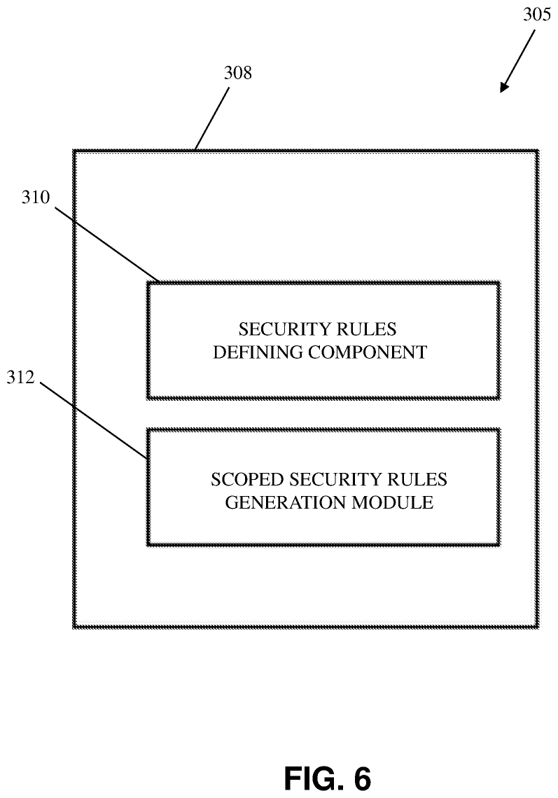

In FIG. 2, and in accordance with aspects of the invention, when the tagging module 212 receives the inbound data (i.e., the source data) from the source system 220, the tagging module 212 retrieves a list of rules that are applicable to an integration flow from a scoped security rules generation module 312, identifies a list of data fields that should be tagged as secrets, and tags the data fields in the list as secrets. The scoped security rules generation module 312 is described herein with respect to FIG. 6. In embodiments, the tagging module 212 sends certain information to the scoped security rules generation module 312 to get security rules which correspond with the inbound data (i.e., the source data). In particular, the tagging module 212 sends a flag to indicate that the information is a tagging rules generation request, initial information (e.g., customer object from system A) of the inbound data (i.e., the source data), and detailed information of a running environment that can be used in the security rules (e.g., the integration flow is owned by a marketing team, an execution date of the integration flow, etc.).

In embodiments, the scoped security rules generation module 312 receives the certain information to determine all of the security rules that correspond with the tagging rules generation request and the inbound data (i.e., the source data). In an example, the scoped security rules generation module 312 determines a security rule in which a home address in customer object of system A is a secret after May 28, 2018 for any integration flow that is owned by the marketing team. The scoped security rules generation module 312 then sends all of the determined security rules to the tagging module 212. Tagging module 212 receives all of the determined security rules and determines the data fields that need to be tagged based on the determined security rules that are applicable to the integration flow. In particular, the tagging module 212 marks the determined data fields as secret if they are saved into a message tree.

In embodiments, the value obscuring module 214 propagates secret tags to new fields of data fields or obscures secret field values of data fields based on the determined security rules received from the scoped security rules generation module 312 in response to data on the message tree being accessed and stored in a different location. In embodiments, the value obscuring module 214 propagates secret tags to new fields of data fields or obscures secret field values of data fields before sending the propagated secret tags and obscured secret field values to the external system 218. In particular, the value obscuring module 214 examines mappings to produce the new fields either on the message tree or on the outbound data to generate a list of secret fields involved in the mappings. Then, the value obscuring module 214 sends predetermined information to the scoped security rules generation module 312 to get security rules which correspond with the outbound data (i.e., the target data). In particular, the value obscuring module 214 sends a flag to indicate that the predetermined information is an obscure rules generation request, initial information of the identified list of secret fields, information of a targeting location (e.g., a field in a message tree, a body of a message of an email system, etc.), and detailed information of the running environment that can be used in the security rules (e.g., the integration flow is owned by the marketing team, the execution date of the integration flow, etc.).

In embodiments, the scoped security rules generation module 312 receives the predetermined information to determine all of the security rules that correspond with the obscure rules generation request and the outbound data (i.e., the target data). In an example, the scoped security rules generation module 312 determines a security rule in which the home address in the customer object of system A is used an input of irreversible functions for any integration flow that is owned by the marketing team. The value obscuring module 214 propagates the secret tags or obscures the value of new fields using the determined security rules that are applicable to the outbound data (i.e., the target data). In particular, the data transformation classification module 215 analyzes and returns the transformation methods that are used on the data fields with secret tags. Further, the rule based value obscure module 216 obscures the data fields that have the secret tags. A security rules defining component 310 defines and validates security rules with available classifications from the data transformation classification module 215. The security rules defining component 310 is described herein with respect to FIG. 6. In particular, a security rules management module 308 includes the security rules defining component 310 and the scoped security rules generation module 312. Further details of the security rules management module 308, the security rules defining component 310, and the scoped security rules generation module 312 are described herein with respect to FIG. 6.

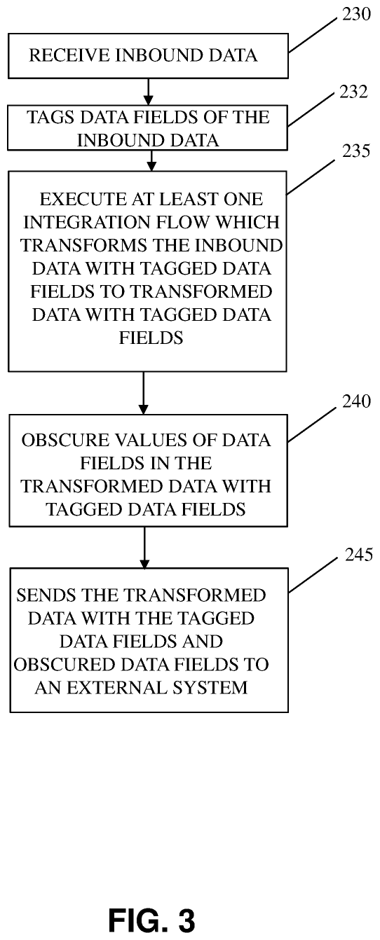

FIG. 3 shows a flowchart of an exemplary method of the workload-based classification server in accordance with aspects of the present invention. Steps of the method may be carried out in the environment of FIG. 2 and are described with reference to elements depicted in FIG. 2.

At step 230, the system receives, at the tagging module 212, inbound data (e.g., the source data) from a source system 220. At step 232, the system tags, at the tagging module 212 data fields of the inbound data. In embodiments, and as described with respect to FIG. 2, the tagging module 212 sends the inbound data with the tagged data fields to the integration runtime module 210.

At step 235, the system executes, at the integration runtime module 210, at least one integration flow during an integration runtime. In embodiments, and as described with respect to FIG. 2, the integration runtime module 210 executes the at least one integration flow which transforms the inbound data with tagged data fields to transformed data with the tagged data fields. In an example, the transformation of the inbound data may include copying entries of an incoming message tree to another message tree and utilizing hashing functions, java code functions, etc. Accordingly, the integration runtime module 210 carries forward the tagged data fields even when the inbound data is transformed to transformed data. The integration runtime module 210 sends the transformed data with the tagged data fields to the value obscuring module 214.

At step 240, the system obscures, at the value obscuring module 214, values of the data fields in the transformed data that should not be leaked according to the tagged data fields. In embodiments, and as described with respect to FIG. 2, the value obscuring module 214 uses security rules corresponding to the tagged data fields to determine whether the values of the data fields in the transformed data should be obscured. At step 245, the system sends, at the value obscuring module 214, the transformed data with the tagged data fields and obscured data fields to an external system 218.

FIG. 4 shows a block diagram of a value obscuring module in accordance with aspects of the present invention. The value obscuring module 214 comprises the data transformation classification module 215 and the rule based value obscure module 216 each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The value obscuring module 214 may include additional or fewer modules than those shown in FIG. 4. In embodiments, separate modules may be integrated into a single module. Additionally, or alternatively, a single module may be implemented as multiple modules.

In embodiments, the data transformation classification module 215 identifies data fields that contain values that are calculated using data with tags. The data transformation classification module 215 classifies data transformation functions that are used to populate a value of each data field and assigns classification tags (e.g., reversible, irreversible). In particular, the data transformation classification module 215 analyzes and returns the transformation methods that are used on the data fields with secret tags. The rule based value obscure module 216 reads the scoped security rules for a current data transportation from the security rules management module 308 and obscures values in the data fields using the tags and the scoped security rules. In an example, the rule based value obscure module 216 obscures the data fields that have the secret tags.

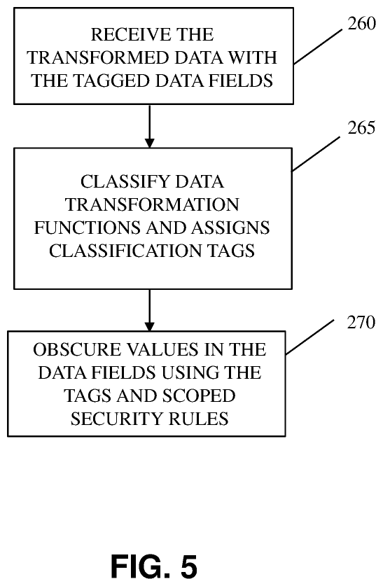

FIG. 5 shows a flowchart of an exemplary method of the value obscuring module in accordance with aspects of the present invention. Steps of the method may be carried out in the environment of FIG. 4 and are described with reference to elements depicted in FIG. 4.

At step 260, the system receives, at the data transformation classification module 215, transformed data with the tagged data fields from the integration runtime module 210. At step 265, the system classifies, at the data transformation classification module 215, data transformation functions that are used to populate a value of each data field. In embodiments, and as described with respect to FIG. 4, the data transformation classification module 215 also assigns classification tags (e.g., reversible, irreversible).

At step 270, the system obscures, at the rule based value obscure module 216, values in the data fields using the tags and scoped security rules. In embodiments, and as described with respect to FIG. 4, the rule based value obscure module 216 receives the scoped security rules for a current data transportation from the security rules management module 308.

FIG. 6 shows a block diagram of an exemplary environment of a security rules management module in accordance with aspects of the present invention. In embodiments, the environment 305 includes the security rules management module 308, which may comprise one or more instances of the computer 101 of FIG. 1. In other examples, the security rules management module 308 comprises one or more virtual machines or one or more containers running on one or more instances of the computer 101 of FIG. 1.

In embodiments, the security rules management module 308 of FIG. 6 comprises the security rules defining component 310 and the scoped security rules generation module 312, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The security rules management module 308 may include additional or fewer modules than those shown in FIG. 6. In embodiments, separate modules may be integrated into a single module. Additionally, or alternatively, a single module may be implemented as multiple modules.

In embodiments, the security rules defining component 310 defines and validates security rules with available classifications from the data transformation classification module 215. The scoped security rules generation module 312 creates a list of rules that are applicable to an integration flow within the integration runtime module 210. In embodiments, the scoped security rules generation module 312 creates a plurality of security rules which correspond with the inbound data (i.e., the source data). In particular, the scoped security rules generation module 312 receives certain information to determine all of the security rules that correspond with the tagging rules generation request and the inbound data (i.e., the source data). In an example, the scoped security rules generation module 312 determines a security rule in which a home address in customer object of system A is a secret after May 28, 2018 for any integration flow within the integration runtime module 210 that is owned by the marketing team. The scoped security rules generation module 312 then sends all of the determined security rules with the inbound data to the tagging module 212.

In embodiments, the scoped security rules generation module 312 receives predetermined information to get security rules which correspond with the outbound data (i.e., the target data). In particular, the value obscuring module 214 sends a flag to indicate that the predetermined information is an obscure rules generation request, initial information of the identified list of secret fields, information of a targeting location (e.g., a field in a message tree, a body of a message of an email system, etc.), and detailed information of the running environment that can be used in the security rules (e.g., the integration flow is owned by the marketing team, the execution date of the integration flow, etc.)

In embodiments, the scoped security rules generation module 312 receives the predetermined information to determine all of the security rules that correspond with an obscure rules generation request and the outbound data (i.e., the target data). In an example, the scoped security rules generation module 312 determines a security rule in which the home address in the customer object of system A is used an input of irreversible functions for any integration flow within the integration runtime module 210 that is owned by the marketing team. The scoped security rules generation module 312 then sends all of the determined security rules with the outbound data to the value obscuring module 214.

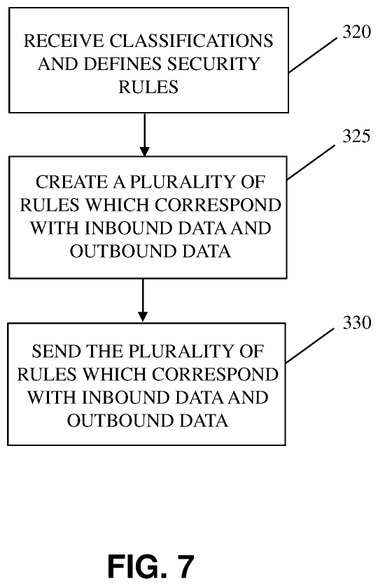

FIG. 7 shows a flowchart of an exemplary method of the security rules management module in accordance with aspects of the present invention. Steps of the method may be carried out in the environment of FIG. 6 and are described with reference to elements depicted in FIG. 6.

At step 320, the system receives, at the security rules defining component 310, classifications from the data transformation classification module 215. In embodiments, and as described with respect to FIG. 6, the security rules defining component 310 also defines and validates security rules using the available classifications from the data transformation classification module 215.

At step 325, the system creates, at the scoped security rules generation module 312, a plurality of security rules for both inbound data (i.e., the source data) and outbound data (i.e., the target data). In embodiments, and as described with respect to FIG. 6, the scoped security rules generation module 312 receives predetermined information to determine all of the security rules that correspond with the outbound data. Further, the scoped security rules generation module 312 receives certain information to determine all of the security rules that correspond with the inbound data.

At step 330, the system sends, at the scoped security rules generation module 312, the plurality of security rules corresponding with the inbound data and the outbound data. In embodiments, and as described with respect to FIG. 6, the scoped security rules generation module 312 sends all of the security rules that correspond with the inbound data to the tagging module 212. Further, the scoped security rules generation module 312 sends all of the security rules that correspond with the outbound data to the value obscuring module 214.

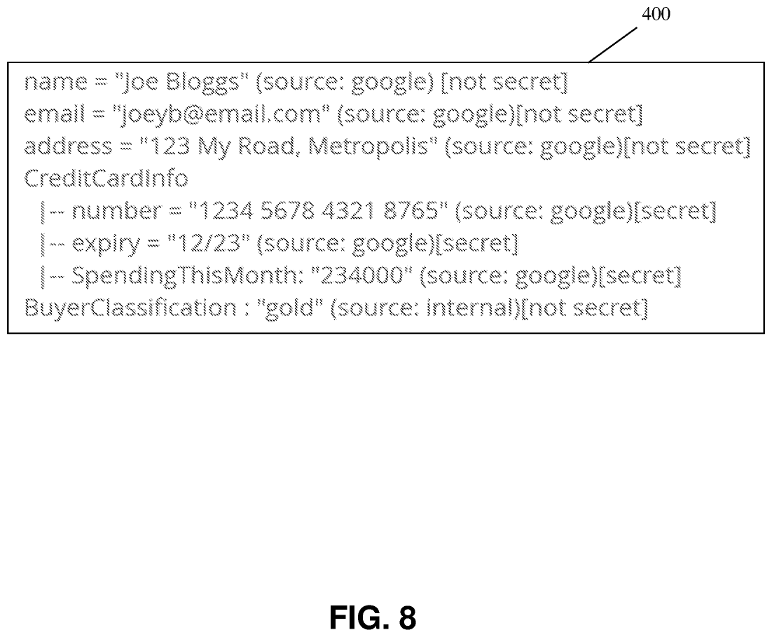

FIG. 8 shows an example of customer information in an internal database in accordance with aspects of the present invention. In particular, the integration runtime server 208 generates the customer information 400 in the internal database in accordance with aspects of the present invention described below.

In an example of embodiments, the integration runtime server 208 receives a single rule to prevent data leakage of sensitive data from a security architect. In particular, the single rule is shown below:
CreditCardInfo in Customer object from a search engine is a secret (Rule 1).

In the first step of the example, the integration runtime server 208 retrieves customer data with browsing history from the search engine. In particular, the following object from the customer data is retrieved from the search engine:

| | |
|---|---|
| name: “Joe Bloggs” | (Object 1). |

email: joeyb@email.com
address: “123 My Road, Metropolis”
CreditCardInfo:
number: “1234 5678 4321 8765”
expiry: “12/23”
SpendingThisMonth: “234000”

In embodiments, the integration runtime server 208 adds source labels to all fields by default. Further, the integration runtime server 208 tags a message tree with secret/not secret tags based on Rule 1 above. In particular, the output of the integration runtime server 208 tagging the message tree with secret/not secret tags is shown below:

| | |
|---|---|
| name: “Joe Bloggs” (source: the search engine) [not secret] | (Object 2). |

```
email: joeyb@email.com (source: the search engine) [not secret]
address: “123 My Road, Metropolis” (source: the search engine) [not secret]
CreditCardInfo:
  | -- number: “1234 5678 4321 8765” (source: the search engine) [secret]
  | -- expiry: “12/23” (source: the search engine) [secret]
  | -- SpendingThisMonth: “234000” (source: the search engine) [secret]
```

In the second step of the example, the integration runtime server 208 populates a new “BuyerClassification” field using the SpendingThisMonth field. Further, the integration runtime server 208 adds the source label to the new “BuyerClassification” field because the new “BuyerClassification” field is computed using a value of SpendingThisMonth and inherits the secret tag as shown below:

| | |
|---|---|
| name: “Joe Bloggs” (source: the search engine) [not secret] | (Object 3). |

```
email: joeyb@email.com (source: the search engine) [not secret]
address: “123 My Road, Metropolis” (source: the search engine) [not secret]
CreditCardInfo:
  | -- number: “1234 5678 4321 8765” (source: the search engine) [secret]
  | -- expiry: “12/23” (source: the search engine) [secret]
  | -- SpendingThisMonth: “234000” (source: the search engine) [secret]
BuyerClassification: “gold” (source: internal) [secret]
```

In the third step of the example, the integration runtime server 208 sends marketing emails through a marketing platform using the value of the new “BuyerClassification” field. Further, the integration runtime server 208 triggers a security check because “CreditCardInfo” and “BuyerClassification” fields are both tagged with the secret tag. Accordingly, the integration runtime server 208 obscures the value of “CreditCardInfo” and “BuyerClassification” fields when data is sent to the marketing platform because no rules are found to allow the value of “CreditCardInfo” and “BuyerClassification” fields as shown below:

| | |
|---|---|
| name: “Joe Bloggs” | (Object 4). |

email: joeyb@email.com
address: “123 My Road, Metropolis”

In embodiments, the marketing platform throws an error which terminates the flow because “BuyerClassification” field is missing from the payload.

In another example of embodiments, the integration runtime server 208 updates security rules to prevent data leakage of sensitive data from a security architect and fix the error above. In particular, the security rules are shown below:

| | |
|---|---|
| CreditCardInfo in Customer object from the search engine is a secret | (Rule 1). |
| CreditCardInfo in Customer object from the search engine can be used | (Rule 2). |

as the input of irreversible functions

In the first step of this example, the integration runtime server 208 retrieves customer data with browsing history from the search engine. In the second step of this example, the integration runtime server 208 populates a new “BuyerClassification” field using the SpendingThisMonth field. Further, the integration runtime server 208 adds the source label to the new “BuyerClassification” field because the new “BuyerClassification” field is computed using a value of SpendingThisMonth and inherits the secret tag. In this example, the integration runtime server 208 includes Rule 2 which transfers the tag into “not secret” for the new “BuyerClassification” field as shown in the customer information 400 of FIG. 8 and reproduced below:

| | |
|---|---|
| name: “Joe Bloggs” (source: the search engine) [not secret] | (Object 5). |

```
email: joeyb@email.com (source: the search engine) [not secret]
address: “123 My Road, Metropolis” (source: the search engine) [not secret]
CreditCardInfo:
  | -- number: “1234 5678 4321 8765” (source: the search engine) [secret]
  | -- expiry: “12/23” (source: the search engine) [secret]
  | -- SpendingThisMonth: “234000” (source: the search engine) [secret]
BuyerClassification: “gold” (source: internal) [not secret]
```

In the third step of this example, the integration runtime server 208 sends marketing emails through the marketing platform using the value of the new “BuyerClassification” field. Further, the integration runtime server 208 triggers a security check because “CreditCardInfo” is tagged with the secret tag. Accordingly, the integration runtime server 208 obscures the value of “CreditCardInfo” field when data is sent to the marketing platform because no rules are found to allow the value of “CreditCardInfo” field as shown below:

| | |
|---|---|
| name: “Joe Bloggs” | (Object 6). |

email: joeyb@email.com
address: “123 My Road, Metropolis”
BuyerClassification: “gold”

In embodiments, an email targeting “gold” buyers is sent to the customer. The integration runtime server 208 saves customer information into an internal database. In particular, the integration runtime server 208 triggers the security check because “CreditCardInfo” is tagged with the secret tag. Accordingly, the integration runtime server 208 obscures the value of “CreditCardInfo” field and only Object 6 is sent to the internal database because no rules are found to allow the value of “CreditCardInfo” to be sent to the internal database.

In another example of embodiments, the integration runtime server 208 updates security rules to allow sensitive data to be stored in internal databases from a security architect. In particular, the security rules are shown below:

| | |
|---|---|
| CreditCardInfo in Customer object from the search engine is a secret | (Rule 1). |
| CreditCardInfo in Customer object from the search engine can be used | (Rule 2). |

as the input of irreversible functions

| | |
|---|---|
| CreditCardInfo in Customer object from the search engine can be sent | (Rule 3). |

to an internal database

In the first step of this example, the integration runtime server 208 retrieves customer data with browsing history from the search engine. In the second step of this example, the integration runtime server 208 populates a new “BuyerClassification” field using the SpendingThisMonth field. Further, the integration runtime server 208 adds the source label to the new “BuyerClassification” field because the new “BuyerClassification” field is computed using a value of SpendingThisMonth and inherits the secret tag. In this example, the integration runtime server 208 includes Rule 2 which transfer the tag into “not secret” for the new “BuyerClassification” field as shown in the customer information 400 of FIG. 8 and reproduced below:

| | |
|---|---|
| name: “Joe Bloggs” (source: the search engine) [not secret] | (Object 5). |

```
email: joeyb@email.com (source: the search engine) [not secret]
address: “123 My Road, Metropolis” (source: the search engine) [not secret]
CreditCardInfo:
  | -- number: “1234 5678 4321 8765” (source: the search engine) [secret]
  | -- expiry: “12/23” (source: the search engine) [secret]
  | -- SpendingThisMonth: “234000” (source: the search engine) [secret]
BuyerClassification: “gold” (source: internal) [not secret]
```

In the third step of this example, the integration runtime server 208 sends marketing emails through the marketing platform using the value of the new “BuyerClassification” field. Further, the integration runtime server 208 triggers a security check because “CreditCardInfo” is tagged with the secret tag. However, in this example, the integration runtime server 208 includes Rule 3 which allows the “CreditCardInfo” field to be sent to the internal database as shown below:

| | |
|---|---|
| name: “Joe Bloggs” | (Object 7). |

email: joeyb@email.com
address: “123 My Road, Metropolis”
CreditCardInfo:
number: “1234 5678 4321 8765”
expiry: “12/23”
SpendingThisMonth: “234000
BuyerClassification: “gold”

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a processor set, inbound data;
tagging, by the processor set, a plurality of data fields of the inbound data;
executing, by the processor set, at least one integration flow which transforms the inbound data with tagged data fields to transformed data with the tagged data fields;
obscuring, by the processor set, values of the data fields in the transformed data based on the tagged data fields; and
sending, by the processor set, outbound data which includes the transformed data with the obscured values of the data fields.

2. The method of claim 1, wherein the obscuring values of the data fields in the transformed data comprises obscuring values of the data fields in the transformed data which are tagged as secret.

3. The method of claim 2, wherein the obscuring values of the data fields in the transformed data further comprises preventing obscuring values of the data fields in the transformed data which are not tagged as secret.

4. The method of claim 1, further comprising receiving a plurality of first security rules to determine the plurality of data fields of the inbound data which is tagged.

5. The method of claim 1, further comprising receiving a plurality of second security rules which are used as an input of at least one irreversible function corresponding to the outbound data.

6. The method of claim 5, wherein the second security rules allow sensitive data to be stored.

7. The method of claim 1, wherein the at least one integration flow which transforms the inbound data with tagged data fields comprises copying entries of an incoming message tree to another message tree.

8. The method of claim 1, wherein the at least one integration flow which transforms the inbound data with tagged data fields comprises utilizing hashing functions.

9. The method of claim 1, wherein the at least one integration flow which transforms the inbound data with tagged data fields comprises utilizing java code functions.

10. The method of claim 1, wherein the inbound data is received from a source system and the outbound data is sent to a target system.

11. The method of claim 10, wherein at least one of the source system and the target system is an external system.

12. A computer program product comprising one or more computer readable storage media having program instructions collectively stored on the one or more computer readable storage media, the program instructions executable to:
receive inbound data from a source system;
tag a plurality of data fields of the inbound data;
execute at least one integration flow utilizing hashing functions which transforms the inbound data with tagged data fields to transformed data with the tagged data fields;
obscure values of the data fields in the transformed data based on the tagged data fields; and
send outbound data which includes the transformed data with the obscured values of the data fields to a target system.

13. The computer program product of claim 12, wherein the source system and the target system are external systems.

14. The computer program product of claim 12, wherein the obscuring values of the data fields in the transformed data comprises obscuring values of the data fields in the transformed data which are tagged as secret.

15. The computer program product of claim 14, wherein the obscuring values of the data fields in the transformed data further comprises preventing obscuring values of the data fields in the transformed data which are not tagged as secret.

16. The computer program product of claim 12, further comprising receiving a plurality of first security rules to determine the plurality of data fields of the inbound data which is tagged.

17. The computer program product of claim 12, further comprising receiving a plurality of second security rules which are used as an input of at least one irreversible function corresponding to the outbound data.

18. The computer program product of claim 17, wherein the second security rules allow sensitive data to be stored.

19. A system comprising:
a processor set, one or more computer readable storage media, and program instructions collectively stored on the one or more computer readable storage media, the program instructions executable to:
receive inbound data from a source system;
tag a plurality of data fields of the inbound data;
execute at least one integration flow comprising copying entries of an incoming message tree to another message tree which transforms the inbound data with tagged data fields to transformed data with the tagged data fields;
obscure values of the data fields in the transformed data based on the tagged data fields; and
send outbound data which includes the transformed data with the obscured values of the data fields to a target system.

20. The system of claim 19, wherein the obscuring values of the data fields in the transformed data comprises obscuring values of the data fields in the transformed data which are tagged as secret.
